(19) United States
(12) Patent Application Publication
(10) Pub. No.: US 2004/0247139 A1
(43) Pub. Date: Dec. 9, 2004

(54) Audio/video remote control with built-in earphone system

(76) Inventor: Randall Wang, Temple City, CA (US)

Correspondence Address: Raymond Y. Chan, Suite 128, 108 N. Ynez Ave., Monterey Park, CA, 91754, US

(21) Appl. No.: 10/636,905

(22) Filed: Aug. 6, 2003

Related U.S. Application Data
(63) Continuation-in-part of application No. 10/454,720, filed on Jun. 3, 2003.

(51) Int. Cl. H04R 1/10

(52) U.S. Cl. 381/74; 381/79

(57) ABSTRACT

A remote control system, which is adapted for wirelessly communicating an earphone with an audio/video system having an audio signal output, includes an audio signal transmitter adapted for operatively connecting to the audio signal output of the audio/video system so as to transmit an audio signal therefrom, and a remote control unit wirelessly connecting to the audio signal transmitter. The remote unit includes, a control circuit for wirelessly operating the audio/video system, and an audio signal receiver including a signal receiving circuit wirelessly communicating with the audio signal transmitter for receiving the audio signal therefrom in a wireless manner, and a signal outlet electrically connected to the signal receiving circuit for connecting with the earphone so as to transmit the audio signal from the audio/video system to the earphone in a wireless manner.

### CROSS REFERENCE OF RELATED APPLICATION

This application is a Continuation-In-Part application of a non-provisional application, application Ser. No. 10/454,720, filed on Jun. 03, 2003.

### BACKGROUND OF THE PRESENT INVENTION

1. Field of Invention

The present invention relates to an earphone system, and more particularly to an audio/video remote control with built-in earphone system, wherein the remote control is capable of not only remotely controlling an audio/video system, such as a television or a stereo, but also connecting with an earphone to wirelessly receive an audio signal from the audio/video system.

2. Description of Related Arts

Most people have the unpleasant experience of being disturbed in mid-night by the sound of an audio/video system. Instead of turn off the volume of the audio/video system, an individual usually use an earphone to enjoy the quality of the sound so as not to disturb the sleeping people.

A conventional headphone comprises a headset and a connecting cable having a predetermined length electrically connected the headset with an audio/video such as television or a stereo. However, the conventional headphone has several drawbacks. When the earphone is electrically connected to the audio/video system, the movement of the user is limited to the length of the connecting cable. In other words, the freedom of movement of the user is restricted so as to limit the distance the user may be from the audio/video system. In addition, the user may be in jeopardy as the user may trip on the connecting cable.

In order to solve the above-mentioned problem, a wireless headphone is needed so that the user is able to enjoy the quality of sound in a wirelessly communication manner. However, the wireless receiver built-in with the headset may be interfered during the head movement of the user, which may affect the quality of sound. Otherwise, the wireless receiver must be employed with a high-end circuit configuration to compensate the audio signal loss during the wireless transmission. However, it will highly increase the cost of the wireless headphone.

In addition, a hand held remote control becomes a common tool for wirelessly controlling the audio/video system. Therefore, no matter the user wears the headphone or not, the user will hold the remote control closely to control the audio/video system. Especially when the user has more than one audio/video system, a universal remote control is the best operation apparatus to control all the audio/video systems in a wireless manner.

### SUMMARY OF THE PRESENT INVENTION

A main object of the present invention is to provide an audio/video remote control with a built-in earphone system, wherein the remote control is capable of not only remotely controlling an audio/video system, such as a television or a stereo, but also connecting with an earphone to wirelessly receive an audio signal from the audio/video system.

Another object of the present invention is to provide an audio/video remote control with a built-in earphone system, wherein the remote control functions as a universal remote control adapted to wirelessly control more than one audio/video system and as an audio signal receiver to wirelessly receive the audio signal sending out from the audio/video system. In other words, the remote control functions as a two-way communication device to send the signal to the control audio/video system and to receive the audio signal therefrom to the earphone.

Another object of the present invention is to provide an audio/video remote control with a built-in earphone system, wherein the remote control is wirelessly communicating with the audio/video system through radio frequency or infrared frequency so as to enhance the stability of the wireless connection between the audio/video system and the remote control.

Another object of the present invention is to provide an audio/video remote control with a built-in earphone system, wherein due to the stability of the remote control, the wireless connection between the audio signal receiver of the remote control and the audio signal transmitter is stabilized in comparison with the conventional wireless connection between the earphone and the audio signal transmitter which may be interfered by the head movement of the user.

Another object of the present invention is to provide an audio/video remote control with a built-in earphone system, wherein the remote control is adapted to incorporate with any existing earphone, such as a headset or an earplug, and audio/video system for facilitating the practical use of the present invention.

Another object of the present invention is to provide a method of transmitting an audio signal from an audio/video system to an earphone through a remote control, wherein the operation of the present invention is easy and simple that by wirelessly communicating the audio/video system with the remote control and then plugging the earphone with the remote control.

Another object of the present invention is to provide an audio/video remote control with a built-in earphone system, wherein no expensive or complicated mechanism is required to employ in the remote control, so that the present invention successfully provides an economic and efficient solution not only for wirelessly transmitting the audio signal from the audio/video system to the earphone through the remote control but also for facilitating the practical use of the remote control.

Accordingly, in order to accomplish the above objects, the present invention provides a remote control system for wirelessly communicating an earphone with an audio/video system having an audio signal output, comprising:

an audio signal transmitter adapted for operatively connecting to the audio signal output of the audio/video system so as to transmit an audio signal therefrom; and

a remote control unit, comprising:

a power source;

a control circuit electrically connected with the power source for wirelessly operating the audio/video system; and

an audio signal receiver comprising a signal receiving circuit wirelessly communicating with the audio signal transmitter for receiving the audio signal therefrom in a wireless manner, and a signal outlet electrically connected to the signal receiving circuit for connecting with the earphone so as to transmit the audio signal from the audio/video system to the earphone in a wireless manner.

The present invention further provides a method of transmitting an audio signal from an audio/video system to an earphone through a remote control system which comprises an audio signal transmitter and an audio signal receiver, comprising the steps of:

(a) communicatively setting up the audio signal transmitter of the remote control system with the audio/video system to obtain the audio signal therefrom;

(b) sending the audio signal from the audio/video system through the audio signal transmitter of the remote control system;

(c) receiving the audio signal by the audio signal receiver of the remote control unit in a wireless manner; and

(d) connecting the remote control unit with the earphone so as to transmit the audio signal from the audio/video system to the earphone in a wireless manner.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an audio/video remote control with a built-in earphone system according to a preferred embodiment of the present invention, illustrating how the remote control incorporating the audio/video system with the earphone.

FIG. 2 is a diagram of the audio/video remote control with a built-in earphone system according to the above preferred embodiment of the present invention.

FIG. 3 is a flow chart of a method of method of transmitting an audio signal from the audio/video system to the earphone through the remote control according to the above preferred embodiment of the present invention.

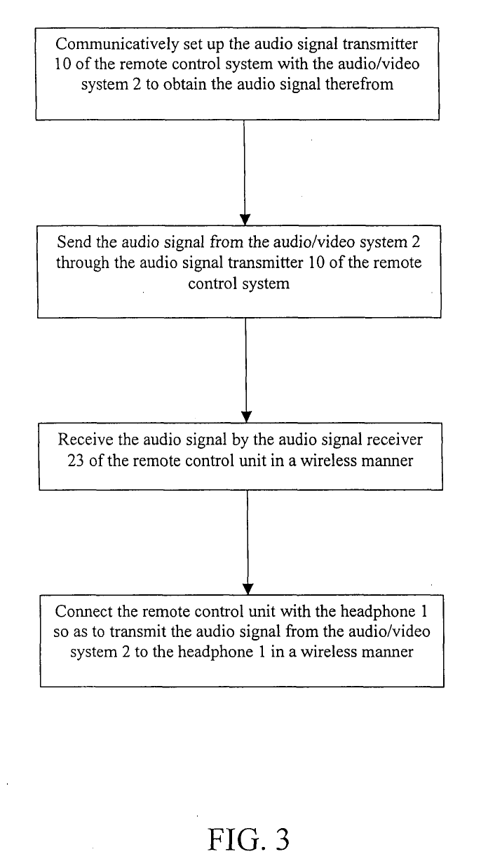

FIG. 4 is a block diagram of the audio/video remote control with a built-in earphone system according to the above preferred embodiment of the present invention.

FIG. 5 is a block diagram of the operation of the audio/video remote control with a built-in earphone system according to the above preferred embodiment of the present invention.

### DETAILED DESCRIPTION OF THE PREFERRED EMBODIMENT

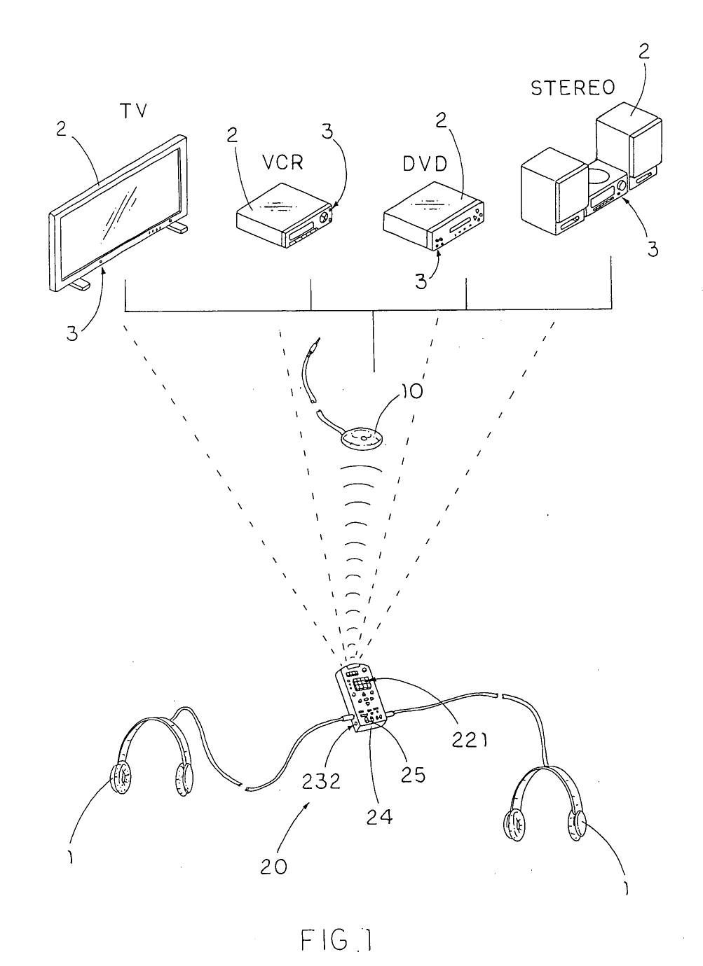

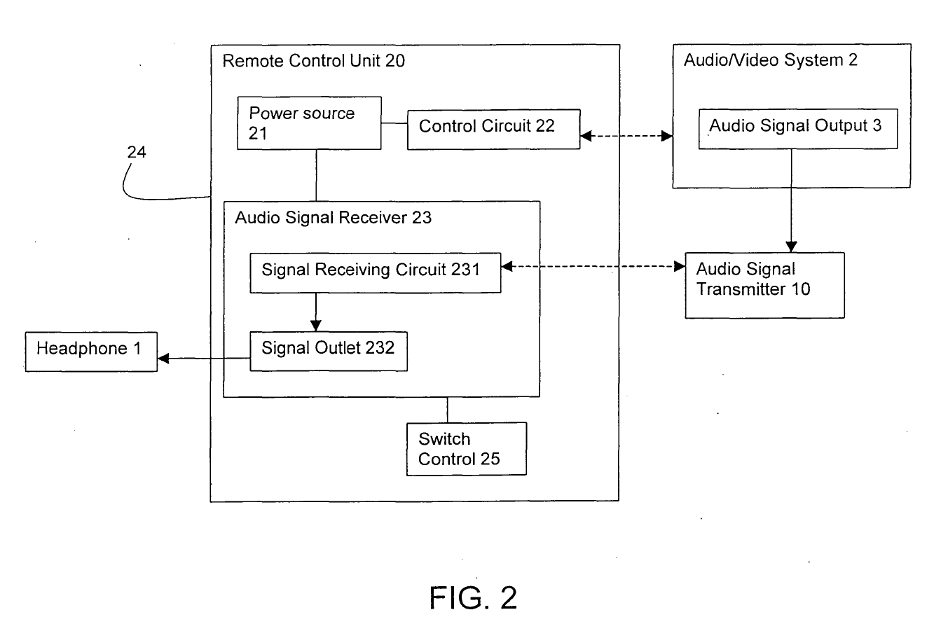

Referring to FIGS. 1 and 2 of the drawings, an audio/video remote control with a built-in earphone system according to a preferred embodiment of the present invention is illustrated, wherein the remote control system is for wirelessly communicating an earphone 1 with an audio/video system 2 having an audio signal output 3.

The remote control system comprises an audio signal transmitter 10 adapted for operatively connecting to the audio signal output 3 of the audio/video system 2 so as to transmit an audio signal therefrom, and a remote control unit 20 comprising a power source 21 and a control circuit 22 electrically connected with the power source 21 for wirelessly operating the audio/video system 2.

The remote control unit 20 further comprises an audio signal receiver 23 comprising a signal receiving circuit 231 wirelessly communicating with the audio signal transmitter 10 for receiving the audio signal therefrom in a wireless manner, and a signal outlet 232 electrically connected to the signal receiving circuit 231 for connecting with the earphone 1 so as to transmit the audio signal from the audio/video system 2 to the earphone 1 in a wireless manner.

The present invention further provides a method of transmitting the audio signal from the audio/video system 2 to the earphone 1 through the remote control system, comprising the following steps.

(1) Communicatively set up the audio signal transmitter 10 of the remote control system with the audio/video system 2 to obtain the audio signal therefrom.

(2) Send the audio signal from the audio/video system 2 through the audio signal transmitter 10 of the remote control system.

(3) Receive the audio signal by the audio signal receiver 23 of the remote control unit in a wireless manner.

(4) Connect the remote control unit with the earphone 1 so as to transmit the audio signal from the audio/video system 2 to the earphone 1 in a wireless manner.

According to the preferred embodiment, the audio signal transmitter 10 comprises a radio frequency transmitting device adapted to send and receive the audio signal in form of radio frequency, wherein the radio frequency transmitter 10 functions as a wireless communication link between the audio signal receiver 23 of the remote control unit 20 and the audio/video system 2. In other words, the audio signal receiver 23 is a radio frequency transmitting device adapted to receive the audio signal in form of radio frequency, wherein the radio frequency transmitting device functions as a wireless communication link with respect to the audio signal transmitter 10 of the audio/video system 2.

Alternatively, the audio signal transmitter 10 comprises an infrared transmitting device adapted to send and receive the audio signal in form of infrared signal, wherein the audio signal transmitter 10 is communicating with the audio signal receiver 23 through infrared signals to remotely communicate with the remote control unit 20 in such a manner that the audio signal transmitter 10 functions as a wireless communication link between the audio signal receiver 23 of the remote control unit 20 and the audio/video system 2. In other words, the audio signal receiver 23 is an infrared transmitting device adapted to receive the audio signal in form of infrared signal, wherein the audio signal receiver 23 is adapted for communicating with the audio transmitter 10 through infrared signals to remotely communicate with the audio/video system 2 in such a manner that the audio signal receiver 23 functions as a wireless communication link with respect to the audio signal transmitter 10 of the audio/video system 2.

It is worth to mention that the audio signal transmitter 10 is generally built-in with most audio/video systems 2 for its corresponding remote control such that the remote control unit 20 of the present invention is adapted to incorporate the built-in audio signal transmitter 10 of the audio/video system 2 by matching the same infrared frequency or the radio frequency of the audio signal transmitter 10 to wirelessly communicate with the audio/video system 2.

In comparison with the radio frequency signals, the communicating range of the infrared signals is shorter than that of the radio frequency signals. However, the infrared signal is more accurate than the radio frequency signal, so that the audio signal from the audio/video system 2 is capable of precisely transmitting to the particularly audio signal receiver 23 through the infrared signals. Especially when two audio signal transmitters 10 are positioned closely, the audio signal receivers 23 are capable of accurately receiving the audio signals from the audio signal transmitters 10 respectively through different channels of the infrared signals.

As shown in FIG. 2, the remote control unit 20 further comprises a hand held case 24 to receive the power source 21, the control circuit 22, and the audio signal receiver 23 in the hand held case 24. Accordingly, the power source 21 comprises a replaceable battery received in the hand held case 24 to electrically connect with the control circuit 22 and the audio signal receiver 23 for supplying electricity. In addition, a built-in high density LED can be provided on the hand held case 24 and electrically connected to the control circuit 22 for indicating the operation of the present invention.

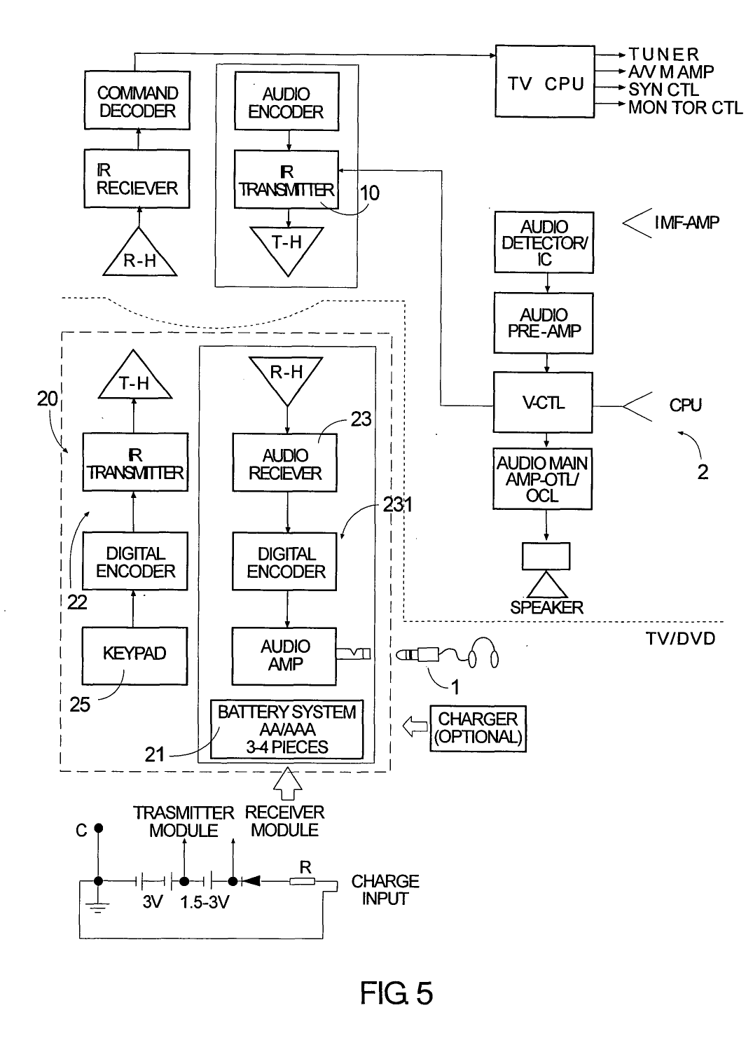

As shown in FIG. 5, the power source 21 can be a rechargeable battery wherein the hand held case 24 is adapted to plug into a battery charger to recharge the rechargeable battery.

The control circuit 20 is a conventional remote control device which is adapted to be programmed to control the operation of the audio/video system in a wireless manner. The control circuit 22, which is generally embodied as a universal remote control, comprises a plurality of function keys 221 to be programmed for selectively controlling more than one audio/video system such as television, video cassette recorder (VCR), digital video player (DVD), compact disk player, and/or stereo system.

Accordingly, in the step (3), the method further comprises a step of:

(3.1) Tune the signal receiving circuit 231 of the audio signal receiver 23 to communicate with the audio signal transmitter 10.

The signal receiving circuit 231 of the audio signal receiver 23 is a wireless signal receiving device adapted to receive and send the audio signal from the audio signal transmitter 10. Accordingly, the audio signal receiver 23 can be automatically or manually tuned to communicate with the audio signal transmitter 10 by programming the signal receiving circuit 231 to match the same radio frequency with the audio signal transmitter 10.

In other words, more than one audio signal receiver 23 can be set to use the same radio frequency by the manufacturer to communicate with the audio signal transmitter 10. Alternatively, the user is also able to manually tune the audio signal receiver 23 to communicatively network with another desirable audio signal transmitter 10 or automatically tune the audio signal receiver 23 to search another audio signal transmitter 10 that is positioned within the coverage area with respect to audio signal transmitter 10. Due to the long range the radio frequency, the audio signal transmitter 10 is capable of communicating with the audio signal receiver 23 of the remote control unit 20 for a predetermined coverage area. Therefore, the audio signal output from the audio/video system 2 can be transmitted to the earphone 1 for distances.

It is worth to mention that the audio signal output from the audio/video system 2 is converted into a radio frequency wherein the audio signal transmitter 10 sends out the audio signal in form of radio frequency to the audio signal receiver 23 while the signal receiving circuit 231 converts the radio frequency back to the normal audio signal so as to transmit the audio signal towards the earphone 1.

Likewise, the user is able to tune the signal receiving circuit 231 of the audio signal receiver 23 at a predetermined infrared signal to communicate with the audio signal transmitter 10 to remotely receive the audio signal from the audio/video system 2 through the remote control unit 20. Alternatively, the audio signal receiver 23 is capable of automatically matching the infrared signal to communicate with the audio signal transmitter 10 to remotely receive the audio signal from the audio/video system 2.

The audio signal output from the audio/Video system 2 is converted into the infrared signal wherein the audio signal transmitter 10 sends out the audio signal in form of infrared signal to the audio signal receiver 23 while the signal receiving circuit 231 converts the infrared signal back to the normal audio signal so as to transmit the audio signal towards the earphone 1.

It is worth to mention that an audio enhancing circuit can be built-in with the signal receiving circuit 231 of the audio signal receiver 23 such that when the audio/video system 2 provides a sound effect, such as “Dolby”, “Digital Theater System (DTS)” “Dolby 5.1 Surround Sound System”, and “Theater Home System (THS)”, the audio enhancing circuit of the signal receiving circuit 231 is capable of directing the sound effect to the earphone 1.

According to the preferred embodiment, the remote control unit 20 further comprises a switch control 25 electrically connected to the signal receiving circuit 231 for controlling a volume of the audio signal transmitted to the signal outlet 232. It is worth to mention that the volume of the audio signal can be selectively controlled by the control circuit 22 of the remote control unit 20 via the function keys 221 thereof to directly adjust the volume of the audio signal output from the audio/video system 2. Or, the earphone 1 comprises a built-in volume control for selectively controlling the volume of the audio signal output from the signal outlet 232. However, the switch control 25 of the remote control unit 20 provides a fine volume adjustment for the audio signal to selectively fine-tune the volume of the audio signal through the signal receiving circuit 231, especially for the conventional earphone without the built-in volume control feature.

The switch control 25 is arranged to wirelessly switch the audio/video system 2 between a speaker mode and an earphone mode. In which, at the speaker mode, the audio signal is output from the speaker of the audio/video system 2 wherein there is no sound output from the earphone 1 through the remote control unit 20. At the earphone mode, the audio signal from the audio/video system 2 is directed to the remote control unit 20 such that there is no sound output from the speaker of the audio/video system 2. For example, to control the audio signal output from the TV as the audio/video system 2, a ‘mute’ function key is preset to switch the TV between the speaker mode and the earphone mode wherein when the ‘mute’ function key is pressed to disable the speaker of the TV such that the user is able to use the earphone 1 plugging into the remote control unit 20 to listen the sound from the TV. Once the ‘mute’ function key is pressed again, the TV is switched back to the speaker mode that the speaker of the TV is enabled to output the audio signal wherein the audio signal transmitter 10 is disabled to block the audio signal sending out to the audio signal receiver 23.

The signal outlet 232 of the remote control unit 20 is provided on the hand held case 24 to electrically connect with the signal receiving circuit 231 wherein the signal outlet 232 is arranged to transmit the audio signal from the signal receiving circuit 231 towards the earphone 1 when the earphone I is connected to the signal outlet 232. Accordingly, the signal outlet 232 comprises a conventional earphone socket in such a manner that any kind of earphone is capable of plugging into the signal outlet 232 for receiving the audio signal therefrom.

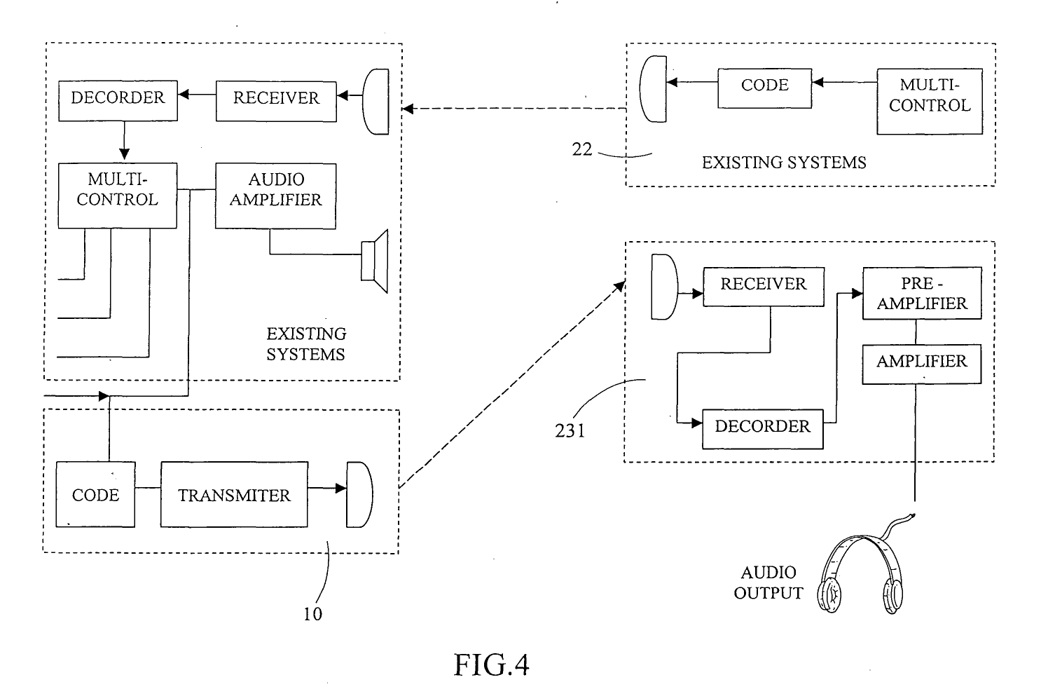

FIGS. 4 and 5 illustrate the remote control unit 20 functions as a two-way communication device to send and receive the signal from the audio/video system 2. Referring to FIG. 4, the conventional remote control, which functions as a signal sender, is arranged to only send out a control signal to the audio/video system 2. According to the preferred embodiment, the remote control unit 20 also functions as a signal receiver to receive the audio signal from the audio/video system 2.

As it is mentioned in the background, when the user wears the earphone 1, the head movement of the user may interfere the wireless connection between the earphone 1 and the audio/video system 2 while the audio receiver is built-in with the earphone 1. Since the remote control unit 20 usually is in a static manner, expect using the remote control unit 20 to wirelessly operate the audio/video system 2, the remote control unit 20 provides a static wireless connection to the audio/video system 2 through the audio signal transmitter 10. In other words, the head movement of the user will not interfere the wireless connection between the earphone 1 and the audio/video system 2 when the remote control system of the present invention is employed.

It is worth to mention that the earphone 1 can be a conventional headset or earplug connected to the signal outlet 232 of the remote control unit 20 to receive the audio signal output from the audio/video system 2 through the remote control unit 20 in a wireless manner.

According to the preferred embodiment, the audio signal transmitter 10 can be built-in with the audio/video system 2 in such a manner that no wire connection is required to electrically connect the audio signal transmitter 10 with the audio/video system 2. In other words, the user is able to only set the remote control unit 20 to wirelessly communicate with the audio signal transmitter 10 in the audio/video system 2 so as to wirelessly receive the audio signal from the audio/video system 2 to the remote control unit 20 via the earphone 1.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A remote control system for wirelessly communicating an earphone with an audio/video system having an audio signal output, comprising:
an audio signal transmitter adapted for operatively connecting to said audio signal output of the audio/video system so as to transmit an audio signal therefrom; and
a remote control unit, comprising:
a power source;
a control circuit electrically connected with said power source for wirelessly operating said audio/video system; and
an audio signal receiver comprising a signal receiving circuit wirelessly communicating said the audio signal transmitter for receiving said audio signal therefrom in a wireless manner, and a signal outlet electrically connected to said signal receiving circuit for connecting with said earphone so as to transmit said audio signal from said audio/video system to said earphone in a wireless manner.

2. The remote control system, as recited in claim 1, wherein said audio signal transmitter comprises a radio frequency transmitting device adapted to send and receive said audio signal in form of radio frequency, wherein said radio frequency transmitting device functions as a wireless communication link between said audio signal receiver of said remote control unit and said audio/video system.

3. The remote control system, as recited in claim 2, wherein said signal receiving circuit of said signal receiver is a wireless signal receiving device adapted for wirelessly receiving said audio signal from said audio transmitter, wherein said receiving circuit is automatically tuned to match with said radio frequency of said audio signal transmitter to wirelessly communicate with said audio signal transmitter.

4. The remote control system, as recited in claim 2, wherein said signal receiving circuit of said signal receiver is a wireless signal receiving device adapted for wirelessly receiving said audio signal from said audio transmitter, wherein said receiving circuit is manually tuned to match with said radio frequency of said audio signal transmitter to wirelessly communicate with said audio signal transmitter.

5. The remote control system, as recited in claim 3, wherein said control unit further comprises a hand held case to receive said power source, said control circuit, and said audio signal receiver in said hand held case.

6. The remote control system, as recited in claim 4, wherein said control unit further comprises a hand held case to receive said power source, said control circuit, and said audio signal receiver in said hand held case.

7. The remote control system, as recited in claim 5, wherein said remote control unit further comprises a switch control electrically connected to said signal receiving circuit for controlling a volume of said audio signal transmitted to said signal outlet.

8. The remote control system, as recited in claim 6, wherein said remote control unit further comprises a switch control electrically connected to said signal receiving circuit for controlling a volume of said audio signal transmitted to said signal outlet.

9. The remote control system, as recited in claim 1, wherein said audio signal transmitter comprises an infrared transmitting device adapted to send and receive said audio signal in form of infrared signal, wherein said audio signal transmitter is communicating with said audio signal receiver through infrared signals to remotely communicate with said remote control unit in such a manner that said audio signal transmitter functions as a wireless communication link between said audio signal receiver of said remote control unit and said audio/video system.

10. The remote control system, as recited in claim 9, wherein said signal receiving circuit of said signal receiver is a wireless signal receiving device adapted for wirelessly receiving said audio signal from said audio transmitter, wherein said receiving circuit is automatically tuned to match with said infrared signal of said audio signal transmitter to wirelessly communicate with said audio signal transmitter.

11. The remote control system, as recited in claim 9, wherein said signal receiving circuit of said signal receiver is a wireless signal receiving device adapted for wirelessly receiving said audio signal from said audio transmitter, wherein said receiving circuit is manually tuned to match with said infrared signal of said audio signal transmitter to wirelessly communicate with said audio signal transmitter.

12. The remote control system, as recited in claim 10, wherein said control unit further comprises a hand held case to receive said power source, said control circuit, and said audio signal receiver in said hand held case.

13. The remote control system, as recited in claim 11, wherein said control unit further comprises a hand held case to receive said power source, said control circuit, and said audio signal receiver in said hand held case.

14. The remote control system, as recited in claim 12, wherein said remote control unit further comprises a switch control electrically connected to said signal receiving circuit for controlling a volume of said audio signal transmitted to said signal outlet.

15. The remote control system, as recited in claim 13, wherein said remote control unit further comprises a switch control electrically connected to said signal receiving circuit for controlling a volume of said audio signal transmitted to said signal outlet.

16. A method of transmitting an audio signal from an audio/video system to an earphone through a remote control system which comprises an audio signal transmitter and an audio signal receiver, comprising the steps of:
(a) communicatively setting up said audio signal transmitter of said remote control system with said audio/video system to obtain said audio signal therefrom;
(b) sending said audio signal from said audio/video system through said audio signal transmitter of said remote control system;
(c) receiving said audio signal by said audio signal receiver of said remote control system in a wireless manner; and
(d) connecting said remote control unit with said earphone so as to transmit said audio signal from said audio/video system to said earphone in a wireless manner.

17. The method, as recited in claim 16, wherein said remote control system comprises an audio signal receiver comprising a signal receiving circuit wirelessly communicating said the audio signal transmitter for receiving said audio signal therefrom in a wireless manner, and a signal outlet electrically connected to said signal receiving circuit for connecting with said earphone.

18. The method, as recited in claim 17, wherein said signal receiving circuit of said audio signal receiver is wirelessly communicating with said audio signal transmitter through radio frequency signals to wirelessly receive said audio signals in form of said radio frequency signals.

19. The method, as recited in claim 18, in step (c), further comprising a step of tuning said signal receiving circuit of said audio signal receiver to match said radio frequency signals of said audio signal transmitter so as to wirelessly communicate said audio signal receiver with said audio signal transmitter.

20. The method, as recited in claim 17, wherein said signal receiving circuit of said audio signal receiver is wirelessly communicating with said audio signal transmitter through infrared signals to wirelessly receive said audio signals in form of said infrared signals.

21. The method, as recited in claim 20, in step (c), further comprising a step of tuning said signal receiving circuit of said audio signal receiver to match said infrared signals of said audio signal transmitter so as to wirelessly communicate said audio signal receiver with said audio signal transmitter.

22. A remote control system for wirelessly communicating an earphone with an audio/video system which comprises an audio signal transmitter to transmit an audio signal therefrom, comprising a remote control for remotely controlling said audio/video system, wherein said remote control unit comprises:
a power source;
a control circuit electrically connected with said power source for wirelessly operating said audio/video system; and
an audio signal receiver comprising a signal receiving circuit for wirelessly communicating said the audio signal transmitter to receive said audio signal therefrom in a wireless manner, and a signal outlet electrically connected to said signal receiving circuit for connecting with said earphone so as to transmit said audio signal from said audio/video system to said earphone in a wireless manner.

23. The remote control system, as recited in claim 22, wherein said audio signal receiver comprises a radio frequency transmitting device adapted to receive said audio signal in form of radio frequency, wherein said radio frequency transmitting device functions as a wireless communication link with respect to said audio signal transmitter of said audio/video system.

24. The remote control system, as recited in claim 23, wherein said signal receiving circuit of said signal receiver is a wireless signal receiving device adapted for wirelessly receiving said audio signal from said audio transmitter, wherein said receiving circuit is automatically tuned for matching with said radio frequency of said audio signal transmitter to wirelessly communicate with said audio signal transmitter.

25. The remote control system, as recited in claim 23, wherein said signal receiving circuit of said signal receiver is a wireless signal receiving device adapted for wirelessly receiving said audio signal from said audio transmitter, wherein said receiving circuit is manually tuned for matching with said radio frequency of said audio signal transmitter to wirelessly communicate with said audio signal transmitter.

26. The remote control system, as recited in claim 24, wherein said control unit further comprises a hand held case to receive said power source, said control circuit, and said audio signal receiver in said hand held case.

27. The remote control system, as recited in claim 25, wherein said control unit further comprises a hand held case to receive said power source, said control circuit, and said audio signal receiver in said hand held case.

28. The remote control system, as recited in claim 22, wherein said audio signal receiver comprises an infrared transmitting device adapted to receive said audio signal in form of infrared signal, wherein said audio signal receiver is adapted for communicating with said audio transmitter through infrared signals to remotely communicate with said audio/video system in such a manner that said audio signal receiver functions as a wireless communication link with respect to said audio signal transmitter of said audio/video system.

29. The remote control system, as recited in claim 28, wherein said signal receiving circuit of said signal receiver is a wireless signal receiving device adapted for wirelessly receiving said audio signal from said audio transmitter, wherein said receiving circuit is automatically tuned for matching with said infrared signal of said audio signal transmitter to wirelessly communicate with said audio signal transmitter.

30. The remote control system, as recited in claim 28, wherein said signal receiving circuit of said signal receiver is a wireless signal receiving device adapted for wirelessly receiving said audio signal from said audio transmitter, wherein said receiving circuit is manually tuned for matching with said infrared signal of said audio signal transmitter to wirelessly communicate with said audio signal transmitter.

31. The remote control system, as recited in claim 29, wherein said control unit further comprises a hand held case to receive said power source, said control circuit, and said audio signal receiver in said hand held case.

32. The remote control system, as recited in claim 30, wherein said control unit further comprises a hand held case to receive said power source, said control circuit, and said audio signal receiver in said hand held case.
